(19) United States
(12) Patent Application Publication
(10) Pub. No.: US 2009/0316892 A1
(43) Pub. Date: Dec. 24, 2009

(54) Crypto micro-module using IEEE 1394 for stream descrambling

(76) Inventor: Brant L. Candelore, San Diego, CA (US)

Correspondence Address: MILLER PATENT SERVICES, 2500 DOCKERY LANE, RALEIGH, NC, 27606, US

(21) Appl. No.: 12/214,632

(22) Filed: Jun. 20, 2008

(51) Int. Cl. H04N 7/167

(52) U.S. Cl. 380/210

(57) ABSTRACT

In certain embodiments, a television receiver circuit has a tuner circuit and a demodulator circuit that cooperatively produce a digital transport stream for a tuned channel as an output therefrom. A transport processor in an SOC receives the digital transport stream and switches the digital transport stream to an IEEE1394 bus if it is conditional access encrypted, or else if the content is unencrypted, the content is sent to a decoder residing in the SOC. A connector is permanently affixed to the circuit board that is in communication with the IEEE1394 bus. A removable crypto micro-module is installed in the connector, having an IEEE1394 compliant bus providing interconnections to the connector, receiving the digital transport stream for the tuned channel and managing conditional access keys for descrambling the tuned channel and for descrambling the tuned channel, and copy protecting the clear channel for delivery across the IEEE 1394 bus back to the transport processor in the SOC. A copy protection decrypter forms a part of the transport processor in the SOC that decrypts the copy protected stream and sends it to the decoder in the SOC. This abstract is not to be considered limiting, since other embodiments may deviate from the features described in this abstract.

### CROSS REFERENCE TO RELATED DOCUMENTS

This application discloses certain implementations of embodiments related to ISO/IEC specification number 7816 compliant devices. This specification is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

In accord with the OpenCable™ Downloadable Conditional Access System (DCAS) initiative, a smartcard ASIC (i.e., an application specific integrated circuit normally used in a pay-television smartcard is soldered to a television receiver device's motherboard. A unique aspect of the DCAS initiative, is that the smart card ASIC can be personalized by the CA provider of a cable service provider. When built-in to a customer's TV, the device can communicate with the headend to receive a download which will configure it for the CA provider used by that particular cable operator, e.g. Motorola, Scientific Atlanta or NDS. A USB 1.1 interface is provided to accelerate the personalization image during initialization. Later, the USB interface provides for faster delivery of Entitlement Control Messages (ECMs) that are demultiplexed by the main CPU and sent to the smartcard ASIC. ECMs provide the access criteria for receiving content along with encrypted keys. When the smartcard ASIC calculates the content key it re-encrypts them for delivery to the decoder/transport System-on-Chip (SOC). The DCAS smart ASIC is performs key management, but does not descramble the content. The details of the smartcard interface are contained in the International Standards Organization (ISO) specifications ISO/IEC 7816, which is hereby incorporated by reference.

One of the problems with the OpenCable™ Downloadable Conditional Access System (DCAS) initiative is that it may be hard to upgrade stream descrambling. Unfortunately, the USB1.1 interface does not have adequate bandwidth to allow for stream descrambling, and there is no clear upgrade path that would since there are substantial challenges to enabling USB2.0 to work properly for a 2-way interface at the required data rates.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a functional block diagram of a television receiver motherboard.

FIG. 2 is a block diagram of a conditional access crypto.

FIG. 3 is a functional block diagram of an exemplary embodiment of a television receiver motherboard consistent with certain embodiments of the present invention.

FIG. 4 is a block diagram of an exemplary embodiment of a SIM crypto micro-module consistent with certain embodiments of the present invention.

FIG. 5 is a block diagram of an exemplary embodiment of a crypto micro-module consistent with certain embodiments of the present invention.

FIG. 6 is a flow chart depicting exemplary operational modes of the various devices consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term SOC (or SoC) is used to mean “System-on-a-chip” and refers to integrating all or many components of an electronic system into a single integrated circuit (chip). It may contain digital, analog, mixed-signal, and often radio-frequency functions—all on one integrated circuit chip (with the possible addition of a few external components). This term may be used herein to also mean a system in a package (SIP), in which case a plurality of chips and/or other circuit components are used in a single package in an equivalent manner. Hence, the term SOC may be interchanged throughout with SIP without change of meaning. An SOC or SIP may incorporate one or more microcontroller, microprocessor or DSP core(s), memory such as ROM, RAM, EEPROM and/or Flash memory, timing circuits, peripheral circuits, interface circuits (analog or digital), voltage regulation, etc. These circuits are appropriately connected with bus or other suitable interconnection as deemed appropriate.

The term “micro-module” is intended to embrace removable circuit modules that are highly integrated and carry out the functions described herein. In the preferred embodiment, the micro-module is similar in physical construction and appearance to flash memory products (except with the functionality described herein) and utilizes a single inline connector configuration, but this is not to be limited.

As noted above, one of the problems with the OpenCable™ Downloadable Conditional Access System (DCAS) initiative is that it may be hard to upgrade stream descrambling. For example, legacy cable systems use the Digital Encryption Standard (DES) which is out-of-date. New services use the Advanced Encryption Standard (AES). Unless the host already supports AES, there would be no way to download a new stream decryption method. DCAS, as currently proposed, uses a “smart card IC” with an ISO 7816-12 interface. ISO 7816-12 includes the serial communication capability of ISO 7816-3 and adds a USB 1.1 interface using the AUX1 and AUX2 pins. The “smart card IC” may be packaged, for example, in either a dual in-line device or ball grid array. It is soldered to the motherboard of the TV receiver device. Such circuitry is referred to herein as “a conditional access (CA) crypto”.

Additionally, once the hardware is fielded using these techniques, it becomes expensive or impossible to change features of the hardware that can be capitalized upon for enhancements to make the cryptography more robust and stay one step ahead of hackers. For example, in the case of AES encryption, the algorithm is publicly known, and thus the hardware can be cloned. However, slight secret modifications to the hardware delivered in a SIM could be implemented that would invalidate all known standard AES algorithms.

While USB version 1.1 is relatively fast, 12 Mbits/second, it is not fast enough to be used to descramble a high definition (HD) digital television stream, which generally requires almost 19 Mbits/second in each direction for a total of 38 Mbits/second. With DCAS, the stream is descrambled by the decoder/transport SOC (i.e., in this case a single IC or packaged circuit that includes the main CPU, the transport processor/and decoder embedded within a television receiver device such as a set top box, set back box or television set). The CA crypto passes keys (encrypted) to the transport processor in the SOC where the stream decryption takes place. Since the above circuitry is soldered to the motherboard, it cannot be readily replaced. However, a new device could be plugged in using a so-called “dongle” into an external Universal Serial Bus USB interface to take-over the security from the embedded CA crypto. The USB1.1 interface accelerates the protocol and exchange of key information between the CA crypto and the host CPU. The CA crypto primarily performs key management.

The internal or external USB interface could presumably be upgraded to a faster USB2.0 interface which has a data throughput of up to 480 Mbits/second. This might even allow multiple streams to flow to/from the crypto processor; however the USB2.0 requires substantial CPU management to move packets from MPEG Transport Streams to the USB and back. While it is theoretically possible to accommodate the 38 Mbits/second per stream required for a program stream using USB2.0 channels, attempts by various parties have encountered problems making a 2-way USB2.0 interface work properly.

IEEE1394, on the other hand, was originally designed for 2-way transport streams to be used. IEEE1394 has isochronous streams which once set-up require minimal management. In accord with certain embodiments consistent with the present invention, an IEEE1394 interface is mapped to the ISO/IEC 7816 smartcard IC used in the CA crypto in addition to or in-lieu of USB2 using the same pin-out. IEEE1394 provides for complete upgrade of stream descrambling and also key management security using a plug-in module that substitutes for the expensive CableCARD™ or similar conditional access security element. By adding the IEEE1394 capability to the CA crypto, encrypted streams may be more easily handled and offloaded to a detachable and upgradeable decryption module.

This is accomplished in certain embodiments by adding a path for stream descrambling that did not previously exist. Also, the updated decryption circuit can be made available on a Single Inline Module (SIM), smart card, or other removable packaging in order to facilitate upgrades. Herein, the decryption module will be referred to as “a SIM crypto micro-module” or “crypto micro-module” or “CA micro-module” interchangeably. Embodiments consistent with the invention might be used not only in the context of OpenCable™, but also for any context, e.g. terrestrial broadcasts, IPTV, satellite, etc.. The new multi-purpose interface could also be used with desktop computers, notebook computers, etc. to add secure descrambling capability outside of the PC which otherwise might be more susceptible to hacking.

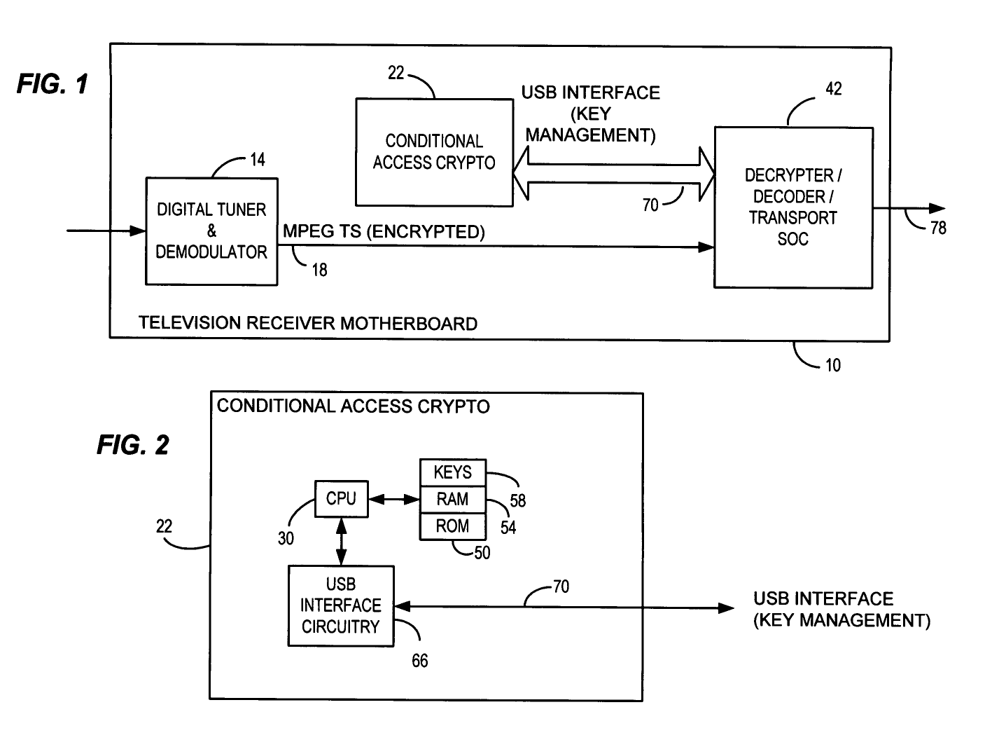

Turning now to FIGS. 1 and 2, a system such as proposed by ISO/IEC 7816 is depicted. In this illustration, a television receiver has a motherboard (a main circuit board or other circuit board) 10 which carries the digital tuner and demodulator circuit 14. The digital tuner and demodulator circuit 14 receives the digital television signals, tunes and demodulates the signal to produce an output encrypted MPEG transports stream (TS) containing the tuned television program and other information at 18. This transport stream is received by the decrypter/decoder/transport SOC 42 that is soldered or otherwise permanently affixed to the motherboard 10. The Conditional Access (CA) crypto 22 is also soldered or otherwise permanently affixed to the motherboard 10. CA crypto 22 can be made up of the circuitry that normally is used in connection with a smartcard and thus carries out key management functions for the enablement of conditional access functions via connection 70 using USB protocols.

The decrypter/decoder/transport SOC 42 incorporates a decrypter (e.g., a DES or AES compliant decrypter) 26 that is used to decrypt the content using keys received and managed by the embedded CA crypto 22. In order to assure the security of the content keys, the CA crypto re-encrypts the content key prior to passing it out to the host using interface 70.

The CA crypto 22's CPU 30 has associated memory such as ROM 50 and RAM 54 which may be used to store instructions and operational parameters as well as encryption and decryption keys 58. Such keys can be managed by the CA management functions of the CPU 30. The CPU 30 can pass the keys and other information as needed to manage the decryption process via a USB interface 66 over USB connection 70 to the host decrypter/decoder/transport SOC 42. The decoder/transport SOC 42 then produces decrypted and decoded output at 78.

As previously noted, one of the problems with the OpenCable Downloadable Conditional Access System (DCAS) initiative is that it may be hard to upgrade stream descrambling (the terms scrambling and encrypting, descrambling and decrypting and related terms are used interchangeably herein). As shown above, the MPEG transport stream at 18 is descrambled by the host decoder/transport SOC 42 embedded within a television receiver device such as a set top box, set back box or television set. This device is considered to be not interchangeable, per se, since it is soldered to the motherboard 10. The embedded micro-module 22 serves to manage the CA process by passing encrypted keys to the decrypter/decoder/transport SOC 42 where the actual decryption takes place. The decrypter/decoder/transport SOC 42 uses a one time programmable memory (OTP) to store a key which may be used to pair 42 with the CA crypto 22. This can be accomplished, for example, by use of the techniques described in U.S. Pat. No. 7,302,058 or U.S. Patent Application Publication no US2004/0158721, which are hereby incorporated by reference, but these techniques should not be considered limiting. This key value may be used by the CA crypto 22 to encrypt the content key for traversal across the ISO-7816 (part 3 or part 12) to a key register in the decrypter/decoder/transport SOC 42.

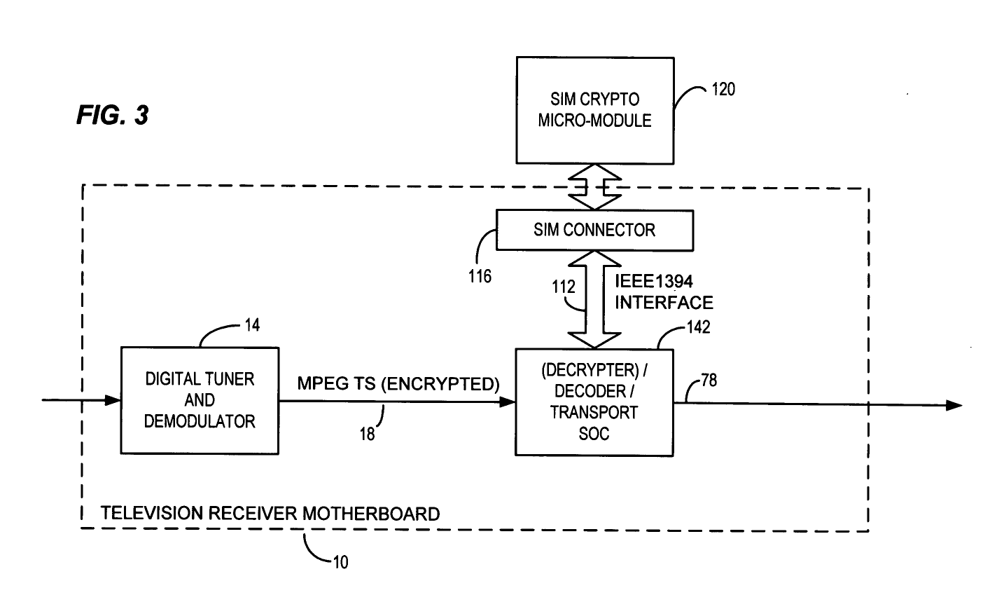

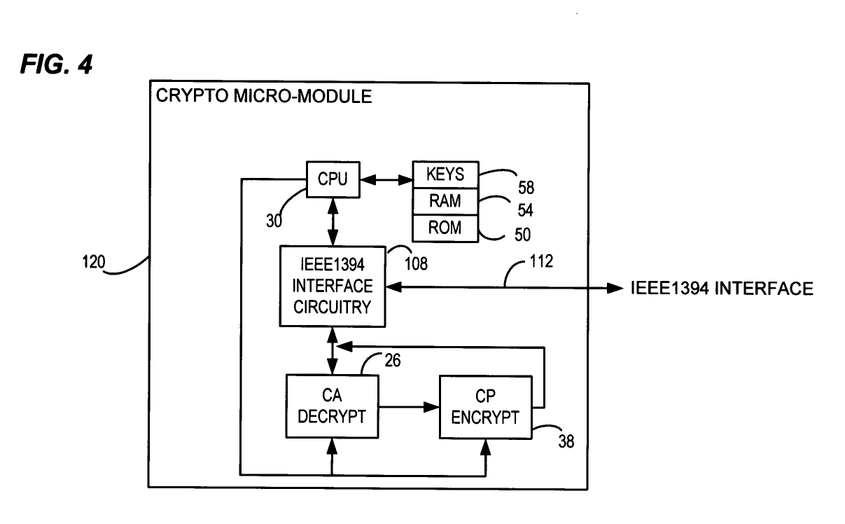

Referring now to FIGS. 3 and 4, an embodiment consistent with the present invention is depicted. In this embodiment, a removable SIM crypto micro-module 120 utilizes an IEEE 1394 interface circuit 108 in a similar capacity as that of the USB interface of CA crypto 22. Except, that the IEEE1394 interface has higher speed capabilities and is more simple to manage using CPU 30 for isochronous two way communication, and moreover, can pass bi-directional video data at speeds high enough to permit the encrypted MPEG transport stream at 18 to be diverted through 42 and out over an IEEE1394 bus 112 destined for a suitable connector 116 situated on the motherboard 10. This connector can be used to plug in an upgraded or upgradeable SIM crypto micro-module 120 having ISO 7816 contacts. As a consequence, SIM crypto micro-module 120 may be used to carry out the decryption function in lieu of having the encryption hardwired and permanent in the receiver motherboard 10 as is the case with (decrypter)/decoder/transport SOC 142. Hence, the key management functions, decryption personality, and decryption can be readily updated and changed by carrying out such functions on the SIM crypto micro-module 120. It is noted that the decoder/transport SOC 142 requires no decrypter (and thus that term may be omitted) in this embodiment, unless a default decryption is to be provided for use in circumstances where a SIM crypto micro-module 120 is not installed. In such a case, the micro-module 120 can function either in the capacity of an upgrade, personality change or simply to manage CA keys.

It is noted that connectors have been standardized for IEEE1394, but embodiments of the invention need not be constrained to such connectors, since a SIM connector or other connector can readily be adapted to the present application. The SIM crypto micro-module 120 may resemble flash memory cards and may be realized by use of an integrated circuit device or devices embedded within a plastic carrier and configured in any convenient physical configuration such as a single inline connector configuration such as is commonly used with various types of flash memory media. In certain embodiments consistent with the present invention, the connector can be embodied as an IS07816-12 compliant connector with the USB AUX1 and AUX2 signals used for IEEE1394 signals instead of USB signals. In certain embodiments, the micro-module has ISO7816 compliant contacts adapted to receive transport streams using IEEE1394 signals. Many variations, however, will occur to those skilled in the art upon consideration of the present teachings.

When a SIM crypto micro-module 120 is plugged in, the encrypted video packets may be passed to the module 120 via the IEEE1394 bus for CA decryption. Once decrypted, they can be re-encrypted prior to leaving the external module using, e.g., DFAST or Digital Transmission Copy Protection (DTCP) encryption at CP encryption block 38, which may use the M6 algorithm, AES or any other suitable algorithm, for the trip back down the bus 112 either directly to the host decoder/transport SOC (where they are decrypted only using algorithms like DES or M6 or the like) before passing to the host decoder 42. The SIM crypto micro-module 120 uses a CA decryption circuit to carry out the conditional access decryption and a copy protection (CP) encryption circuit or function 38 to re-encrypt the content for the trip back out of the module 120. In certain embodiments, module 120 incorporates a CPU processor 30 that carries out the key management functions using stored keys 58 and ROM 50 and RAM 54 and other suitable peripheral functional blocks (not shown for ease of understanding).

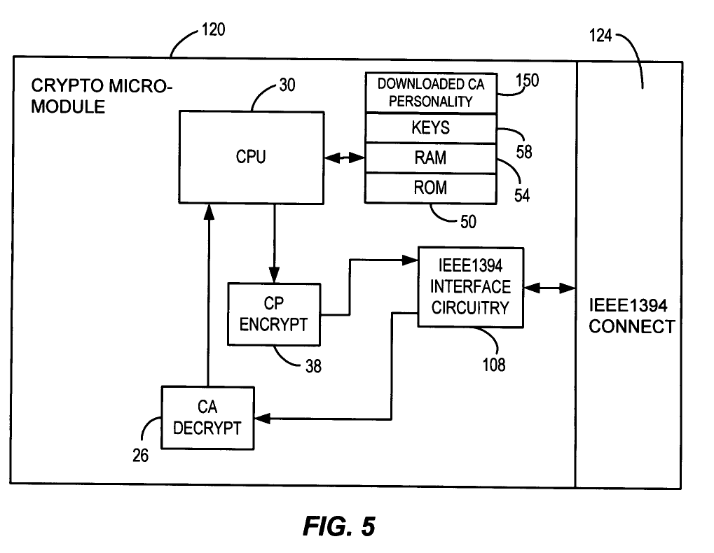

Another similar exemplary SIM crypto micro-module 120 is depicted in FIG. 5. In this module, the encrypted video enters the module via IEEE1394 connector 124 where it passes to IEEE1394 interface circuit 108. Connector 124 is shown separately to emphasize that any type of connector that can carry the signals used by IEEE1394 can be used for this module 120. The packets are decrypted at decrypter 38 before passing to the CPU 30. CPU operates according to stored keys 58 and in accord with programming instructions that establish the conditional access decryption personality 150 (e.g., type of proprietary or non-proprietary decryption mechanism, decryption parameters and version thereof, etc.) of the module 120 which is also stored in the memory including RAM 54 and ROM 50. Once decrypted, the packets are then re-encrypted at AES encrypter 26 for transport back to either the host decoder/transport SOC 142 or CA micro-module 100 via the IEEE1394 bus 112. Keys are passed to the decryption module 120 encrypted using, for example the AES encryption, so that neither content nor decryption keys are ever exposed along traces of the motherboard 10 without first being encrypted.

In the event either the content or the content provider necessitates that the decryption algorithm or some other attribute of the decryption or the decryption keys are to be changed, information used to effect such change can be exchanged using the IEEE1394 bus 112 to reprogram the decryption module's memory—either by download and transport over interface 112 or by removal and reprogramming (or replacement) of module 120.

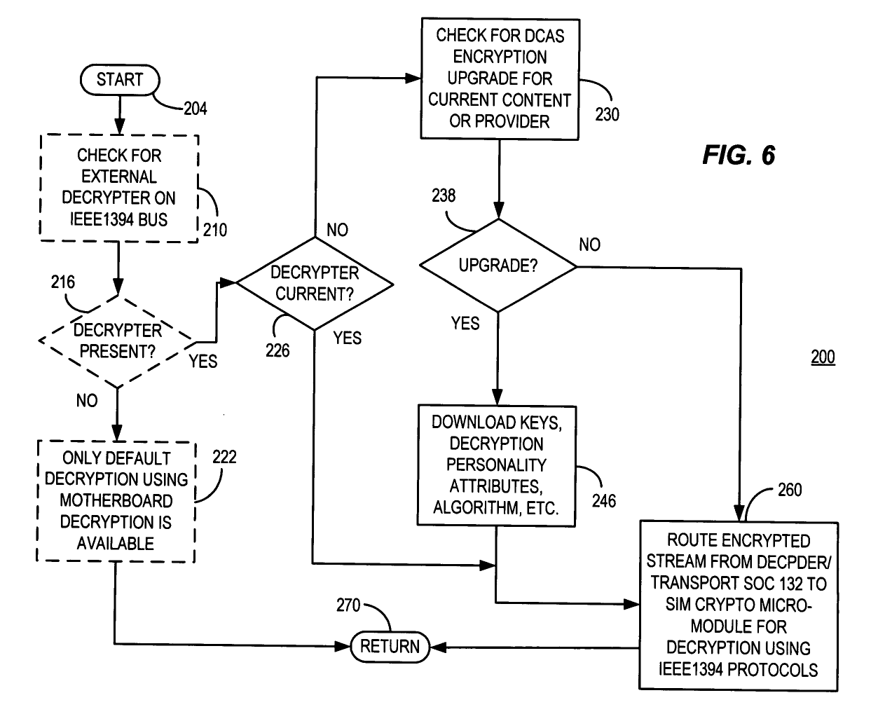

Referring now to FIG. 6, an exemplary process flow chart 200 is depicted starting at 204 illustrating both a decryption upgrade and the associated processing for decryption. In this example, the dashed blocks 210, 216 and 222 indicate functions that would only be carried out if the motherboard 10's decoder/transport SOC 142 incorporated a default decrypter function. Otherwise, these blocks can be omitted. In this simplified example, the process checks the IEEE1394 bus at 210 (or checks other indicators) for the presence of a decryption module in the connector that communicates with the IEEE1394 bus. At 216, if the decrypter is not found on the bus, then the television receiver is only able to use the standard decryption present on the motherboard's decrypter/decoder/transport SOC 142. The process can then take various actions in the event the content cannot be decoded (e.g., provide error messages, etc.) before returning at 270 or can proceed with decryption if the default decrypter of SOC 142 is capable of carrying out the decryption.

If a decrypter is present at 216 (or if no decryption is possible at SOC 142), control passes to 226 where a determination can be made whether the decryption function is current (i.e., compatible with the currently encrypted content or the current content provider. If so, control passes to 260, but if not control passes to 230 where a check is carried out for DCAS encryption upgrade to either match the current content or content provider at 230. If a match is found, an upgrade can take place provided all upgrade criteria are met (e.g., the existence of an appropriate subscription). If an upgrade is to take place at 238, keys, decryption personality attributes, decryption algorithms or other data needed for decryption can be downloaded at 246 and stored in the SIM crypto micro-module 120's memory. The process can then proceed to 260 where the decoder/transport SOC 142 routes the video content via the IEEE1394 bus to the decryption module 120 for the decryption to be carried out. The decrypted content is then re-encrypted and sent to back to the SOC 142 decoder 42 for decoding.

It will be appreciated by those skilled in the art upon consideration of the present teachings that the Digital Encryption Standard (DES) and Advance Encryption Standard (AES) encryption are used as the example encryption in certain embodiments consistent with the present invention. However, other encryption techniques could also be used without departing from embodiments of the invention. It is also noted that the term “micro-module” has been used throughout, since implementations of similar circuitry can be implemented using very small physical devices. However, no size constraints are intended to be imposed upon embodiments of the present invention and the term “module” can be used interchangeably therewith.

In each instance above, the digital television receiver tuner and demodulator, the SOC 142 and the connector 116 are permanently “affixed” to the motherboard, meaning they are permanently soldered in place or otherwise affixed to (e.g., as in a soldered connector) or fabricated as a part of the circuit board in a permanent fashion (e.g., as would be the case for an edge connector). The SIM crypto micro-module 120, however, is intended to be a module that is readily installed and then removable for upgrading or revision of the decryption personality or algorithm. Moreover, in certain preferred embodiments, the personality or other attributes of the module can be modified by download of appropriate code. While it is appreciated that soldered connections can be un-soldered, it is also understood by those skilled in the art that there is a distinction between this and a circuit that is considered removable by virtue of plugging the circuit into or otherwise mating the circuit with a connector. Thus, the term “permanently affixed” is intended to be construed in contrast to a circuit that is installed or removed by a comparatively simple plugging or unplugging action.

It is also noted that the above embodiments of FIGS. 3, 4 and 5 are shown as having only an IEEE1394 interface. However, nothing should be construed to prohibit the inclusion of the IEEE1394 interface in addition to others such as USB or other interfaces.

Thus, in certain embodiments, a television receiver circuit has a tuner circuit and a demodulator circuit that cooperatively produce a digital transport stream for a tuned channel as an output therefrom. A transport processor in an SOC receives the digital transport stream and switches the digital transport stream to an IEEE1394 bus if it is conditional access encrypted, or else if the content is unencrypted, the content is sent to a decoder residing in the SOC. A connector is permanently affixed to the circuit board that is in communication with the IEEE1394 bus. A removable crypto micro-module is installed in the connector, having an IEEE1394 compliant bus providing interconnections to the connector, receiving the digital transport stream for the tuned channel and managing conditional access keys for descrambling the tuned channel and for descrambling the tuned channel, and copy protecting the clear channel for delivery across the IEEE 1394 bus back to the transport processor in the SOC. A copy protection decrypter forms a part of the transport processor in the SOC that decrypts the copy protected stream and sends it to the decoder in the SOC.

In certain embodiments, the connector comprises an ISO7816-12 compliant connector, and wherein USB AUX1 and AUX2 signals are used for IEEE1394 signals instead of USB signals. In certain embodiments, the micro-module has ISO7816 compliant contacts adapted to receive transport streams using IEEE1394 signals. the crypto micro-module further comprises a programmable personality. the programmable personality can be programmed by program instructions transferred to the crypto micro-module via the IEEE1394 bus. the connector comprises a single inline module connector and wherein the crypto micro-module is adapted to mate to the single inline module connector.

A television receiver device circuit board consistent with certain embodiments has a television receiver circuit permanently affixed to the circuit board and producing an digital transport stream for a tuned channel as an output therefrom. A decoder/transport SOC is permanently affixed to the circuit board and receiving the digital transport stream for the tuned channel. A removable crypto micro-module manages conditional access decryption keys and carries out decryption of encrypted content. A connector js permanently affixed to the circuit board, wherein the connector is adapted to receive the removable crypto micro-module. The crypto micro-module has an IEEE1394 compliant bus providing interconnections to the connector. The crypto micro-module is further connected to the decoder/transport SOC circuit via the IEEE1394 compliant bus. The crypto micro-module manages decryption keys used by the crypto micro-module and routes video content to the decoder/transport Soc.

In certain embodiments, the decoder/transport SOC incorporates a decrypter and wherein, the crypto micro-module manages decryption keys used by the decoder/transport SOC via the IEEE1394 compliant bus when the host decrypter is used for decrypting the video content. In certain embodiments, an encryption circuit residing on the crypto micro-module that copy protection encrypts video content destined for the decoder/transport SOC. In certain embodiments, the removable decryption module further has a programmable decryption engine, wherein the programmable decryption engine can be programmed by program instructions transferred to the removable decryption module via the IEEE1394 bus. In certain embodiments, the connector comprises a single inline module connector and wherein the removable decryption module is adapted to mate to the single inline module connector. In certain embodiments, the connector comprises an ISO7816-12 compliant connector, and wherein USB AUX1 and AUX2 signals are used for IEEE 1394 signals instead of USB signals. In certain embodiments, the micro-module has ISO7816 compliant contacts adapted to receive transport streams using IEEE1394 signals. In certain embodiments, the crypto micro-module further has a programmable personality. In certain embodiments, the programmable personality can be programmed by program instructions transferred to the crypto micro-module via the IEEE1394 bus. In certain embodiments, the connector comprises a single inline module connector and wherein the crypto micro-module is adapted to mate to the single inline module connector.

In another embodiment consistent with the present invention, a television receiver device circuit board has a television receiver circuit permanently affixed to the circuit board and producing an digital transport stream for a tuned channel as an output therefrom. A decoder/transport SOC is permanently affixed to the circuit board and receiving the digital transport stream for the tuned channel. A removable crypto micro-module manages conditional access decryption keys and carries out decryption of encrypted content. A connector is permanently affixed to the circuit board, wherein the connector is adapted to receive the removable crypto micro-module. The crypto micro-module has an IEEE1394 compliant bus providing interconnections to the connector. The crypto micro-module is further connected to the decoder/transport SOC circuit via the IEEE1394 compliant bus. The crypto micro-module manages decryption keys used by the crypto micro-module and routes video content to the decoder/transport SOC. The decoder/transport SOC incorporates a decrypter, wherein, the crypto micro-module manages decryption keys used by the decoder/transport SOC via the IEEE1394 compliant bus when the host decrypter is used for decrypting the video content. The removable decryption module further has a programmable decryption engine, wherein the programmable decryption engine can be programmed by program instructions transferred to the removable decryption module via the IEEE1394 bus. The connector has a single inline module connector and the removable decryption module is adapted to mate to the single inline module connector. The connector has an ISO7816-12 compliant connector, and USB AUX1 and AUX2 signals are used for IEEE1394 signals instead of USB signals. The micro-module has ISO7816 compliant contacts adapted to receive transport streams using IEEE1394 signals. The crypto micro-module further has a programmable personality and the programmable personality can be programmed by program instructions transferred to the crypto micro-module via the IEEE1394 bus.

In certain embodiments, the connector comprises a single inline module connector and wherein the crypto micro-module is adapted to mate to the single inline module connector. In certain embodiments, an encryption circuit resides on the crypto micro-module that copy protection encrypts video content destined for the decoder/transport SOC.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

While certain illustrative embodiments have been described, it is evident that many alternatives, modifications, permutations and variations will become apparent to those skilled in the art in light of the foregoing description.

What is claimed is:

1. A television receiver circuit, comprising:
a tuner circuit and a demodulator circuit that cooperatively produce a digital transport stream for a tuned channel as an output therefrom;
a transport processor in an SOC which receives the digital transport stream and switches the digital transport stream to an IEEE1394 bus if it is conditional access encrypted, or else if the content is unencrypted, the content is sent to a decoder residing in the SOC;
a connector permanently affixed to the circuit board that is in communication with the IEEE1394 bus;
a removable crypto micro-module installed in the connector, having an IEEE1394 compliant bus providing interconnections to the connector, receiving the digital transport stream for the tuned channel and managing conditional access keys for descrambling the tuned channel and for descrambling the tuned channel, and copy protecting the clear channel for delivery across the IEEE 1394 bus back to the transport processor in the SOC;
a copy protection decrypter forming a part of the transport processor in the SOC that decrypts the copy protected stream and sends it to the decoder in the SOC.

2. The circuit according to claim 1, wherein the connector comprises an ISO7816-12 compliant connector, and wherein USB AUX1 and AUX2 signals are used for IEEE1394 signals instead of USB signals.

3. The circuit according to claim 1, wherein the micro-module has ISO7816 compliant contacts adapted to receive transport streams using IEEE1394 signals.

4. The circuit according to claim 1, wherein the crypto micro-module further comprises a programmable personality.

5. The circuit according to claim 4, wherein the programmable personality can be programmed by program instructions transferred to the crypto micro-module via the IEEE1394 bus.

6. The television receiver device according to claim 1, wherein the connector comprises a single inline module connector and wherein the crypto micro-module is adapted to mate to the single inline module connector.

7. A television receiver device circuit board, comprising:
a television receiver circuit permanently affixed to the circuit board and producing an digital transport stream for a tuned channel as an output therefrom;
a decoder/transport SOC permanently affixed to the circuit board and receiving the digital transport stream for the tuned channel;
a removable crypto micro-module that manages conditional access decryption keys and carries out decryption of encrypted content;
a connector permanently affixed to the circuit board, wherein the connector is adapted to receive the removable crypto micro-module;
the crypto micro-module having an IEEE1394 compliant bus providing interconnections to the connector;
the crypto micro-module further being connected to the decoder/transport SOC circuit via the IEEE1394 compliant bus; and
wherein the crypto micro-module manages decryption keys used by the crypto micro-module and routes video content to the decoder/transport SOC.

8. The television receiver device circuit board according to claim 7, wherein the decoder/transport SOC incorporates a decrypter and wherein, the crypto micro-module manages decryption keys used by the decoder/transport SOC via the IEEE1394 compliant bus when the host decrypter is used for decrypting the video content.

9. The television receiver device circuit board according to claim 7, further comprising an encryption circuit residing on the crypto micro-module that copy protection encrypts video content destined for the decoder/transport SOC.

10. The television receiver device according to claim 7, wherein the removable decryption module further comprises a programmable decryption engine, wherein the programmable decryption engine can be programmed by program instructions transferred to the removable decryption module via the IEEE1394 bus.

11. The television receiver device according to claim 7, further comprising an encryption circuit residing on the crypto micro-module.

12. The television receiver device circuit board according to claim 7, wherein the connector comprises a single inline module connector and wherein the removable decryption module is adapted to mate to the single inline module connector.

13. The television receiver device circuit board according to claim 7, wherein the connector comprises an ISO7816-12 compliant connector, and wherein USB AUX1 and AUX2 signals are used for IEEE1394 signals instead of USB signals.

14. The television receiver device circuit board according to claim 7, wherein the micro-module has ISO7816 compliant contacts adapted to receive transport streams using IEEE1394 signals.

15. The television receiver device circuit board according to claim 7, wherein the crypto micro-module further comprises a programmable personality.

16. The television receiver device circuit board according to claim 15, wherein the programmable personality can be programmed by program instructions transferred to the crypto micro-module via the IEEE1394 bus.

17. The television receiver device circuit board according to claim 7, wherein the connector comprises a single inline module connector and wherein the crypto micro-module is adapted to mate to the single inline module connector.

18. A television receiver device circuit board, comprising:
a television receiver circuit permanently affixed to the circuit board and producing an digital transport stream for a tuned channel as an output therefrom;
a decoder/transport SOC permanently affixed to the circuit board and receiving the digital transport stream for the tuned channel;
a removable crypto micro-module that manages conditional access decryption keys and carries out decryption of encrypted content;
a connector permanently affixed to the circuit board, wherein the connector is adapted to receive the removable crypto micro-module;
the crypto micro-module having an IEEE1394 compliant bus providing interconnections to the connector;
the crypto micro-module further being connected to the decoder/transport SOC circuit via the IEEE1394 compliant bus;
wherein the crypto micro-module manages decryption keys used by the crypto micro-module and routes video content to the decoder/transport SOC;
wherein the decoder/transport SOC incorporates a decrypter and wherein, the crypto micro-module manages decryption keys used by the decoder/transport SOC via the IEEE1394 compliant bus when the host decrypter is used for decrypting the video content;
wherein the removable decryption module further comprises a programmable decryption engine, wherein the programmable decryption engine can be programmed by program instructions transferred to the removable decryption module via the IEEE1394 bus;
wherein the connector comprises a single inline module connector and wherein the removable decryption module is adapted to mate to the single inline module connector;
wherein the connector comprises an ISO7816-12 compliant connector, and wherein USB AUX1 and AUX2 signals are used for IEEE1394 signals instead of USB signals;
wherein the micro-module has ISO7816 compliant contacts adapted to receive transport streams using IEEE1394 signals; and
wherein the crypto micro-module further comprises a programmable personality and the programmable personality can be programmed by program instructions transferred to the crypto micro-module via the IEEE1394 bus.

19. The television receiver device circuit board according to claim 18, wherein the connector comprises a single inline module connector and wherein the crypto micro-module is adapted to mate to the single inline module connector.

20. The television receiver device circuit board according to claim 18, further comprising an encryption circuit residing on the crypto micro-module that copy protection encrypts video content destined for the decoder/transport SOC.
